(19) United States
(12) Patent Application Publication
(10) Pub. No.: US 2004/0242813 A1
(43) Pub. Date: Dec. 2, 2004

(54) Process for the preparation of hydroxy-vinyl-aromatic polymers or copolymers by anionic or controlled radical polymerization

(76) Inventors: Peter Nesvadba, Marly (CH); Kazuhiko Kunimoto, Hyogo (JP)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/489,045

(22) PCT Filed: Sep. 2, 2002
(86) PCT No.: PCT/EP02/09782

(30) Foreign Application Priority Data
Sep. 10, 2001 (EP) 01810868.8

(51) Int. Cl. C08F 4/72; C08F 4/06

(52) U.S. Cl. 526/135; 526/108

(57) ABSTRACT

The instant invention relates to a process for the preparation of hydroxy-vinyl-aromatic polymers in particular 4-hydroxystyrene polymers or copolymers by anionic or controlled radical polymerization of the respective monomer, wherein the hydroxy functionality is blocked with a protective group which is subsequently removed in a hydrogenation process. The resulting (co)polymers have a narrow polydispersity and are useful for manufacturing photoresists.

The instant invention relates to a process for the preparation of hydroxy-vinyl-aromatic polymers in particular 4-hydroxystyrene polymers or copolymers by controlled radical polymerization of the respective monomer, wherein the hydroxy functionality is blocked with a protective group which is subsequently removed in a hydrogenation process. The resulting (co)polymers have a narrow polydispersity and are useful for manufacturing photoresists.

Hydroxy-vinyl aromatic polymers are very useful binder components for negative and positive acting photoresists. Important properties of the photoresist formulation, such as resolution and time for developing, depend strongly on the molecular weight of the hydroxy-vinyl aromatic polymers and of its molecular distribution.

A narrow molecular weight distribution is of high importance since it influences the glass transition temperature of the polymer. When the polymer is used in a resist formulation a glass transition temperature of above 130° C. is desirable.

Many attempts have therefore been made to prepare poly-(4-hydroxy-styrene) with a well defined molecular weight and narrow molecular weight distribution. One approach has been, to use anionic polymerization for the preparation of poly-(4-hydroxy-styrene). This polymerization process is not easy to handle, since traces of impurities, such as oxygen or water, have a negative impact on the polymer's properties.

Recently a method for the preparation of poly-(4-hydroxy-styrene) by controlled radical polymerization has been disclosed in U.S. Pat. No. 6,107,425. The method described therein uses nitroxyl radicals or alkoxyamines as regulating/initiating compounds. In particular 2,2,6,6-tetramethyl-piperidine-1-oxyl is used as regulating agent.

Controlled polymerization using alkoxyamines or stable free nitroxyl radicals together with a source of free radicals (radical initiator) is known. U.S. Pat. No. 4,581,429 to Solomon et al., issued Apr. 8, 1986, discloses a free radical polymerization process which controls the growth of polymer chains to produce short chain or oligomeric homopolymers and copolymers, including block and graft copolymers. This type of polymerization is frequently called “living polymerization”. The process employs an initiator having the formula (in part) R′R″N—O—X, where X is a free radical species capable of polymerizing unsaturated monomers. The reactions typically have low conversion rates. Specifically mentioned radical R′R″N—O• groups are derived from 1,1,3,3 tetraethylisoindoline, 1,1,3,3 tetrapropylisoindoline, 2,2,6,6 tetramethylpiperidine, 2,2,5,5 tetramethylpyrrolidine or di-t-butylamine.

U.S. Pat. No. 5,322,912 to Georges et al. issued Jun. 21, 1994 discloses a polymerization process using a free radical initiator, a polymerizable monomer compound and a stable free radical agent of the basic structure R′R″N—O• for the synthesis of homopolymers and block copolymers.

Since 4-hydroxy-styrene itself is thermally not very stable it can undergo spontaneous polymerization, or the free OH-group can interact with the regulating or initiating radicals in the controlled radical polymerization process. U.S. Pat. No. 6,107,425 suggests therefore to firstly react the OH-group with a protective group, then to polymerize under controlled conditions and finally to remove the protective group by an acidic or basic treatment to obtain again the free OH-group.

All protective groups suggested in U.S. Pat. No. 6,107,425 are groups, which can be removed by acid or base treatment. Examples are acetyl, trialkylsilyl or sulfonyl groups.

The present invention differs from this prior art process in that a protective group is used, which can be removed in a hydrogenation reaction. By this means very pure hydroxy-vinyl aromatic polymers can be obtained. The degree of hydrogenation can be controlled much more precisely than could be done by a base or acid treatment. It is therefore easily possible to arrive at any conversion percentage. The amount of OH-groups can be chosen from a few percent to complete conversion of 100%. In some cases it can be advantageous to hydrogenate also partly the aromatic ring, thus further modifying the polymers properties.

A further advantage of removing the protective group in a hydrogenation step is that the resulting polymer is free of any discoloration and in particular shows a very low absorption around 248 nm which is important when the polymer is used in a resist formulation.

Furthermore nitroxyl end groups coming from the controlled radical polymerization are also removed under these conditions and the remaining polymer is therefore thermally stable. This is also an important aspect for its use in resist formulations as for example described in JP2000-26535, Sumitomo Chemical Co., Ltd.

One aspect of the instant invention is a process for the preparation of a narrow molecular weight distributed hydroxy-vinyl aromatic oligomer, cooligomer, polymer or copolymer with a polydispersity M_{w}/Mₙ between 1 and 2, which process comprises the steps reacting a composition of at least one monomer of formula I

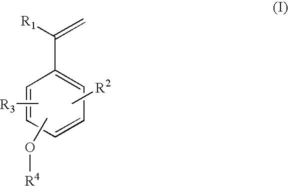

wherein

R₁ is H or CH₃;

R₂ and R₃ are independently C₁-C₈alkyl, C₁-C₈alkoxy, C₁-C₈alkoxycarbonyl, C₁-C₈alkylthio,

C₁-C₈dialkylamino, trihalogenmethyl;

R₄ is benzyl which is unsubstituted or substituted with one or two C₁-C₈alkyl, C₁-C₈alkoxy, C₁-C₈alkoxycarbonyl, C₁-C₈alkylthio, C₁-C₈dialkylamino, trihalogenmethyl, halogen; or R₄ is a group (phenyl)(methyl)CH—, (phenyl)₂CH— or phenyl-CH₂—O—C(O)—;

a1) in the presence of at least one nitroxylether having the structural element

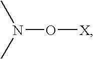

wherein X represents a group having at least one carbon atom and is such that the free radical X• derived from X is capable of initiating polymerization of ethylenically unsaturated monomers; or

a2) in the presence of at least one stable free nitroxyl radical

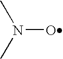

and a free radical initiator; or

a3) in the presence of a compound of formula

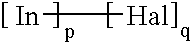

and a catalytically effective amount

of an oxidizable transition metal complex catalyst, wherein

p represents a number greater than zero and defines the number of initiator fragments;

q represents a number greater than zero;

[In] represents a radically transferable atom or group capable of initiating polymerization and

—[Hall] represents a leaving group; or

a4) in an anionic polymerization reaction in the presence of a metal or organo metal catalyst;

and optionally simultaneously or in a subsequent step with one or more ethylenically unsaturated monomers different from those of formula (I); and

b) isolating the resulting polymer and subjecting it to a hydrogenation reaction giving a polymer with repeating units of formula II

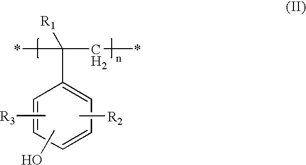

and with a degree of OH-groups of between 10 mol % and 100 mol %, based on the molar amount of protected hydroxy-vinyl aromatic monomer of formula I.

A specific embodiment of the instant invention is a process for the preparation of a narrow molecular weight distributed hydroxy-vinyl aromatic oligomer, cooligomer, polymer or copolymer with a polydispersity M_{w}/Mₙ between 1 and 2, which process comprises the steps reacting a composition of at least one monomer of formula I

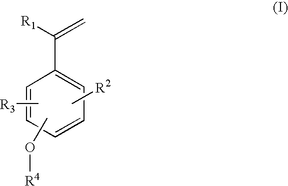

wherein

R₁ is H or CH₃;

R₂ and R₃ are independently C₁-C₈alkyl, C₁-C₈alkoxy, C₁-C₈alkoxycarbonyl, C₁-C₈alkylthio,

C₁-C₈dialkylamino, trihalogenmethyl;

R₄ is benzyl which is unsubstituted or substituted with one or two C₁-C₈alkyl, C₁-C₈alkoxy, C₁-C₈alkoxycarbonyl, C₁-C₈alkylthio, C₁-C₈dialkylamino, trihalogenmethyl, halogen; or R₄ is a group (phenyl)(methyl)CH—, (phenyl)₂CH— or phenyl-CH₂—O—C(O)—;

a1) in the presence of at least one nitroxylether having the structural element

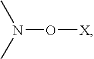

wherein X represents a group having at least one carbon atom and is such that the free radical X• derived from X is capable of initiating polymerization of ethylenically unsaturated monomers; or

a2) in the presence of at least one stable free nitroxyl radical

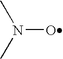

and a free radical initiator; or

a3) in the presence of a compound of formula

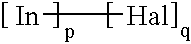

and a catalytically effective amount of an oxidizable transition metal complex catalyst, wherein

p represents a number greater than zero and defines the number of initiator fragments;

q represents a number greater than zero;

[In] represents a radically transferable atom or group capable of initiating polymerization and

—[Hall] represents a leaving group;

and optionally simultaneously or in a subsequent step with one or more ethylenically unsaturated monomers different from those of formula (I); and

b) isolating the resulting polymer and subjecting it to a hydrogenation reaction giving a polymer with repeating units of formula II

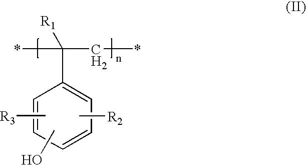

and with a degree of OH-groups of between 10 mol % and 100 mol %, based on the molar amount of protected hydroxy-vinyl aromatic monomer of formula I.

The radical polymerization reaction of steps a1), a2) and a3) is preferably carried out at a temperature between 50° C. and 180° C.;

The anionic polymerization reaction may for example be carried out at a temperature between −100° C. and 150° C.

Preferred is a process wherein in formula I R₁ is H; R₂ and R₃ are H; OR₄ is in the 4-position and R₄ is benzyl or a group (phenyl)₂CH— or phenyl-CH₂—O—C(O)—.

The starting monomer 4-benzyloxystyrene can be prepared for example from 4-acetoxystyrene according to EP 589 621 or from 4-benzyloxyacetophenone according to Tetrahedron 235, (1975). Other substituted styrene derivatives of formula (I) can be prepared in analogy.

The nitroxylethers and nitroxyl radicals are principally known from U.S. Pat. No. 4,581,429 or EP-A-621 878. Particularly useful are the open chain compounds described in WO 98/13392, WO 99/03894 and WO 00/07981, the piperidine derivatives described in WO 99/67298 and GB 2335190 or the heterocyclic compounds described in GB 2342649 and WO 96/24620. Further suitable nitroxylethers and nitroxyl radicals are described in WO 02/4805 and in European Patent Application No. 01810567.6.

Preferably the nitroxylether of component b1) is of formula A, B or O,

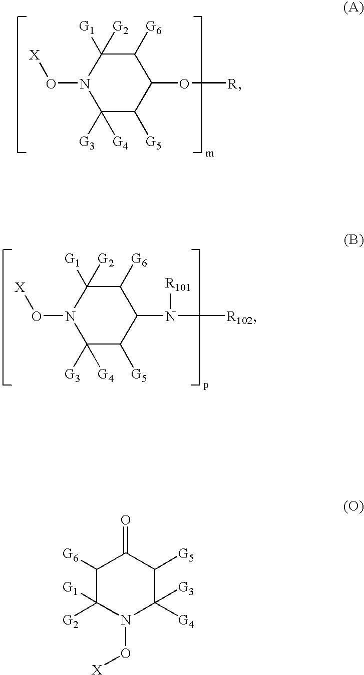

wherein

m is 1,

R is hydrogen, C₁-C₁₈alkyl which is uninterrupted or interrupted by one or more oxygen atoms, cyanoethyl, benzoyl, glycidyl, a monovalent radical of an aliphatic carboxylic acid having 2 to 18 carbon atoms, of a cycloaliphatic carboxylic acid having 7 to 15 carbon atoms, or an α,β-unsaturated carboxylic acid having 3 to 5 carbon atoms or of an aromatic carboxylic acid having 7 to 15 carbon atoms;

p is 1;

R₁₀₁ is C₁-C₁₂alkyl, C₅-C₇cycloalkyl, C₇-C₈aralkyl, C₂-C₈alkanoyl, C₃-C₅alkenoyl or benzoyl;

R₁₀₂ is C₁-C₁₈alkyl, C₅-C₇cycloalkyl, C₂-C₈alkenyl unsubstituted or substituted by a cyano, carbonyl or carbamide group, or is glycidyl, a group of the formula —CH₂CH(OH)—Z or of the formula —CO—Z or —CONH—Z wherein Z is hydrogen, methyl or phenyl;

G₆ is hydrogen and G₅ is hydrogen or C₁-C₄alkyl,

G₁ and G₃ are methyl and G₂ and G₄ are ethyl or propyl or G₁ and G₂ are methyl and G₃ and

G₄ are ethyl or propyl; and

X is selected from the group consisting of —CH₂-phenyl, CH₃CH-phenyl, (CH₃)₂C-phenyl, (C₅-C₆cycloalkyl)₂CCN, (CH₃)₂CCN,

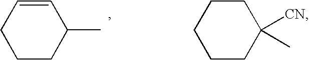

—CH₂CH═CH₂, CH₃CH—CH═CH₂(C₁-C₄alkyl)CR₂₀—C(O)-phenyl, (C₁-C₄)alkyl-CR₂₀—C(O)—(C₁-C₄)alkoxy, (C₁-C₄)alkyl-CR₂₀—C(O)—(C₁-C₄)alkyl, (C₁-C₄)alkyl-CR₂₀—C(O)—N-di(C₁-C₄)alkyl, (C₁-C₄)alkyl-CR₂₀—C(O)—NH(C₁-C₄)alkyl, (C₁-C₄)alkyl-CR₂₀—C(O)—NH₂, wherein

R₂₀ is hydrogen or (C₁-C₄)alkyl.

More preferably in formula A, B and O

R is hydrogen, C₁-C₁₈alkyl, cyanoethyl, benzoyl, glycidyl, a monovalent radical of an aliphatic, carboxylic acid;

R₁₀₁ is C₁-C₁₂alkyl, C₇-C₈aralkyl, C₂-C₁₈alkanoyl, C₃-C₅alkenoyl or benzoyl;

R₁₀₂ is C₁-C₁₈alkyl, glycidyl, a group of the formula —CH₂CH(OH)—Z or of the formula —CO—Z, wherein Z is hydrogen, methyl or phenyl; and

X is CH₃—CH-phenyl.

The above compounds and their preparation are described in GB 2335190 and GB 2 361 235.

Another preferred group of nitroxylethers of component b1) are those of formula (Ic), (Id), (Ie), (If), (Ig) or (Ih)

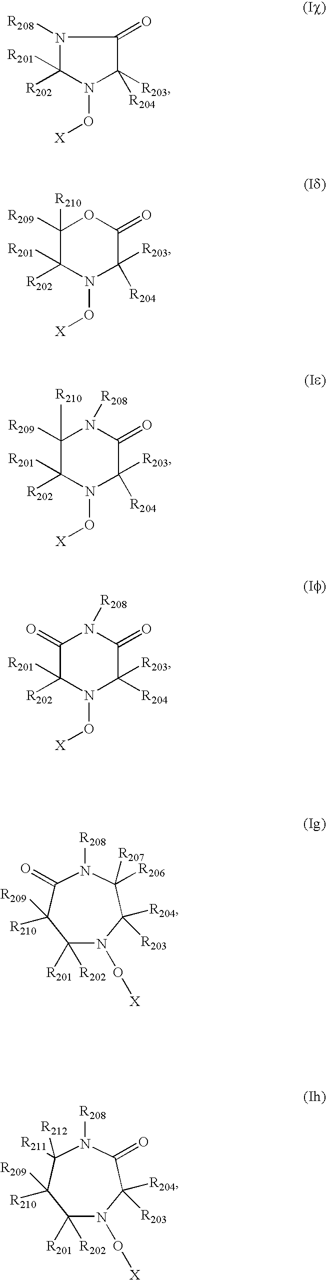

wherein R₂₀₁, R₂₀₂, R₂₀₃ and R₂₀₄ independently of each other are C₁-C₁₈alkyl, C₃-C₁₈alkenyl, C₃-C₁₈alkinyl, C₁-C₁₈alkyl, C₃-C₁₈alkenyl, C₃-C₁₈alkinyl which are substituted by OH, halogen or a group —O—C(O)—R₂₀₅, C₂-C₁₈alkyl which is interrupted by at least one O atom and/or NR₂₀₅ group, C₃-C₁₂cycloalkyl or C₈-C₁₀aryl or R₂₀, and R₂₀₂ and/or R₂₀₃ and R₂₀₄ togetherwith the linking carbon atom form a C₃-C₁₂cycloalkyl radical;

R₂₀₅, R₂₀₆ and R₂₀₇ independently are hydrogen, C₁-C₁₈alkyl or C₆-C₁₀aryl;

R₂₀₈ is hydrogen, OH, C₁-C₁₈alkyl, C₃-C₁₈alkenyl, C₃-C₁₈alkinyl, C₁-C₁₈alkyl, C₃-C₁₈alkenyl, C₃-C₁₈alkinyl which are substituted by one or more OH, halogen or a group —O—C(O)—R₂₀₅, C₂-C₁₈alkyl which is interrupted by at least one O atom and/or NR₂₀₅ group, C₃-C₁₂cycloalkyl or C₆-C₁₀aryl, C₇-C₉phenylalkyl, C₅-C₁₀heteroaryl, —C(O)—C₁-C₁₈alkyl, —O—C₁-C₁₈alkyl or —COOC₁-C₁₈alkyl;

R₂₀₉, R₂₁₀, R₂₁₁, and R₂₁₂ are independently hydrogen, phenyl or C₁-C₁₈alkyl; and

X is selected from the group consisting of —CH₂-phenyl, CH₃CH-phenyl, (CH₃)₂C-phenyl, (C₅-C₆cycloalkyl)₂CCN, (CH₃)₂CCN,

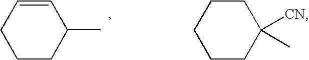

—CH₂CH═CH₂, CH₃CH—CH═CH₂(C₁-C₄alkyl)CR₂₀—C(O)-phenyl, (C₁-C₄)alkyl-CR₂₀—C(O)—(C₁-C₄)alkoxy, (C₁-C₄)alkyl-CR₂₀—C(O)—(C₁-C₄)alkyl, (C₁-C₄)alkyl-CR₂₀—C(O)—N-di(C₁-C₄)alkyl, (C₁-C₄)alkyl-CR₂₀—C(O)—NH(C₁-C₄)alkyl, (C₁-C₄)alkyl-CR₂₀—C(O)—NH₂, wherein R₂₀ is hydrogen or (C₁-C₄)alkyl.

More preferably in formula (Ic), (Id), (Ie), (f), (Ig) and (Ih) at least two of R₂₀₁, R₂₀₂, R₂₀₃ and R₂₀₄ are ethyl, propyl or butyl and the remaining are methyl; or

R₂₀₁, and R₂₀₂ or R₂₀₃ and R₂₀₄ together with the linking carbon atom form a C₅-C₆cycloalkyl radical and one of the remaining substituents is ethyl, propyl or butyl.

Most preferably X is CH₃CH-phenyl.

The above compounds and their preparation is described in GB 2342649.

When a nitroxyl radical is used together with a free radical initiator, the nitroxyl radical of component b2) is preferably of formula A′, B′or O′,

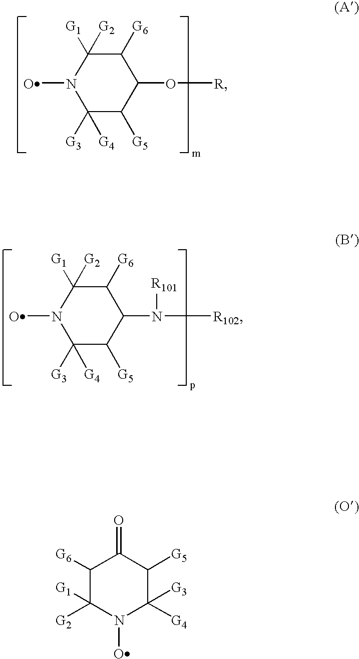

wherein

m is 1,

R is hydrogen, C₁-C₁₈alkyl which is uninterrupted or interrupted by one or more oxygen atoms, cyanoethyl, benzoyl, glycidyl, a monovalent radical of an aliphatic carboxylic acid having 2 to 18 carbon atoms, of a cycloaliphatic carboxylic acid having 7 to 15 carbon atoms,

or an α,βunsaturated carboxylic acid having 3 to 5 carbon atoms or of an aromatic carboxylic acid having 7 to 15 carbon atoms;

is 1;

R₁₀₁, is C₁-C₁₂alkyl, C₅-C₇cycloalkyl, C₇-C₈aralkyl, C₂-C₁₈alkanoyl, C₃-C₅alkenoyl or benzoyl;

R₁₀₂ is C₁-C₁₈alkyl, C₅-C₇cycloalkyl, C₂-C₈alkenyl unsubstituted or substituted by a cyano, carbonyl or carbamide group, or is glycidyl, a group of the formula —CH₂CH(OH)—Z or of the formula —CO—Z or —CONH—Z wherein Z is hydrogen, methyl or phenyl;

G₆ is hydrogen and G₅ is hydrogen or C₁-C₄alkyl, and

G₁ and G₃ are methyl and G₂ and G₄ are ethyl or propyl or G₁ and G₂ are methyl and G₃ and

G₄ are ethyl or propyl.

More preferably in formula A′, B′and O′

R is hydrogen, C₁-C₁₈alkyl, cyanoethyl, benzoyl, glycidyl, a monovalent radical of an aliphatic, carboxylic acid;

R₁₀₁, is C₁-C₁₂alkyl, C₇-C₈aralkyl, C₂-C₁₈alkanoyl, C₃-C₅alkenoyl or benzoyl;

R₁₀₂ is C₁-C₁₈alkyl, glycidyl, a group of the formula —CH₂CH(OH)—Z or of the formula —CO—Z, wherein Z is hydrogen, methyl or phenyl.

The above compounds and their preparation are described in GB 2335190 and GB 2 361 235.

Another preferred group of nitroxyl radicals are those of formula (Ic′), (Id′), (Ie′), (If′), (Ig′) or (Ih′)

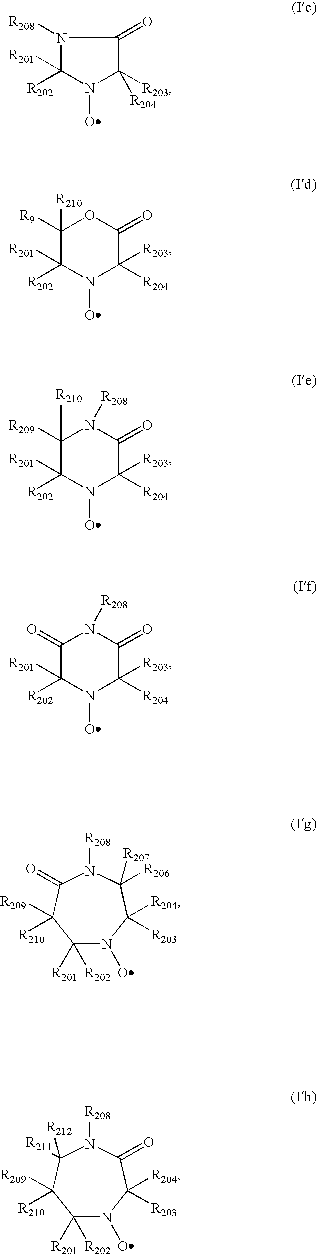

wherein R₂₀₁, R₂₀₂, R₂₀₃ and R₂₀₄ independently of each other are C₁-C₁₈alkyl, C₃-C₁₈alkenyl C₃-C₁₈alkinyl, C₁-C₁₈alkyl, C₃-C₁₈alkenyl, C₃-C₁₈alkinyl which are substituted by OH, halogen or a group —O—C(O)—R₂₀₅, C₂-C₁₈alkyl which is interrupted by at least one O atom and/or NR₂₀₅ group, C₃-C₁₂cycloalkyl or C₆-C₁₀aryl or R₂₀₁ and R₂₀₂ and/or R₂₀₃ and R₂₀₄ together with the linking carbon atom form a C₃-C₁₂cycloalkyl radical;

R₂₀₅, R₂₀₆ and R₂₀₇ independently are hydrogen, C₁-C₁₈alkyl or C₆-C₁₀aryl;

R₂₀₈ is hydrogen, OH, C₁-C₁₈alkyl, C₃-C₁₈alkenyl, C₃-C₁₈alkinyl, C₁-C₁₈alkyl, C₃-C₁₈alkenyl, C₃-C₁₈alkinyl which are substituted by one or more OH, halogen or a group —O—C(O)—R₂₀₅, C₂-C_{C}₁₈alkyl which is interrupted by at least one O atom and/or NR₂₀₅ group, C₃-C₁₂cycloalkyl or C₆-C₁₀aryl, C₇-C₉phenylalkyl, C₅-C₁₀heteroaryl, —C(O)—C₁-C₁₈alkyl, —O—C₁-C₁₈alkyl or —COOC₁-C₁₈alkyl; and

R₂₀₉, R₂₁₀, R₂₁₁ and R₂₁₂ are independently hydrogen, phenyl or C₁-C₁₈alkyl.

More preferably in formula (Ic′), (Id′), (Ie′), (If′), (Ig′) and (Ih′) at least two of R₂₀₁, R₂₀₂, R₂₀₃ and R₂₀₄ are ethyl, propyl or butyl and the remaining are methyl; or

R₂₀₁ and R₂₀₂ or R₂₀₃ and R₂₀₄ together with the linking carbon atom form a C₅-C₆cycloalkyl radical and one of the remaining substituents is ethyl, propyl or butyl.

The above compounds and their preparation is described in GB 2342649.

Other suitable compounds are the 4-imino piperidine derivatives of formula V

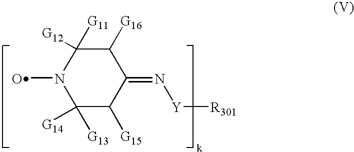

G₁₁, G₁₂, G₁₃ and G₁₄ are independently C₁-C₄alkyl or G₁₁, and G₁₂ together and G₁₃ and G₁₄ together, or G₁ and G₂ together are pentamethylene;

G₁₅ and G₁₆ are each independently of the other hydrogen or C₁-C₄alkyl;

k is 1, 2, 3, or 4

Y is O NR₃₀₂ or when n is 1 and R₃₀₁ represents alkyl or aryl Y is additionally a direct bond; R₃₀₂ is H, C₁-C₁₈alkyl or phenyl;

if k is 1

R₃₀₁ is H, straight or branched C₁-C₁₈alkyl, C₃-C₁₈alkenyl or C₃-C₁₈alkinyl, which may be unsubstituted or substituted, by one or more OH, C₁-C₈alkoxy, carboxy, C₁-C₈alkoxycarbonyl; C₅-C₁₂cycloalkyl or C₅-C₁₂cycloalkenyl;

phenyl, C₇-C₉phenylalkyl or naphthyl which may be unsubstituted or substituted by one or more C₁-C₈alkyl, halogen, OH, C₁-C₈alkoxy, carboxy, C₁-C₈alkoxycarbonyl;

—C(O)—C₁-C₃₆alkyl, or an acyl moiety of a αβ-unsaturated carboxylic acid having 3 to 5 carbon atoms or of an aromatic carboxylic acid having 7 to 15 carbon atoms;

—SO₃⁻Q⁺, —PO(O⁻Q⁺)₂, —P(O)(OR₂)₂, —SO₂—R₂, —CO—NH—R₂, —CONH₂, COOR₂, or Si(Me)₃, wherein Q⁺ is H⁺, ammonium or an alkali metal cation;

if k is 2

R₃₀₁, is Cₗ-C₁₈alkylene, C₃-C₁₈alkenylene or C₃-C₁₈alkinylene, which may be unsubstituted or substituted, by one or more OH, C₁-C₈alkoxy, carboxy, C₁-C₈alkoxycarbonyl; or xylylene; or

R₃₀₁ is a bisacyl radical of an aliphatic dicarboxylic acid having 2 to 36 carbon atoms, or a cycloaliphatic or aromatic dicarboxylic acid having 8-14 carbon atoms;

if k is 3,

R₃₀₁ is a trivalent radical of an aliphatic, cycloaliphatic or aromatic tricarboxylic acid; and

if k is 4, R₃₀₁ is a tetravalent radical of an aliphatic, cycloaliphatic or aromatic tetracarboxylic acid.

Preferably G₁₆ is hydrogen and G₁₅ is hydrogen or C₁-C₄alkyl, in particular methyl, and G₁ and G₃ are methyl and G₂ and G₄ are ethyl or propyl or G₁ and G₂ are methyl and G₃ and G₄ are ethyl or propyl.

The 4 imino compounds of formula V can be prepared for example according to E. G. Rozantsev, A. V. Chudinov, V. D. Sholle.: Izv. Akad. Nauk. SSSR, Ser. Khim. (9), 2114 (1980), starting from the corresponding 4-oxonitroxide in a condensation reaction with hydroxylamine and subsequent reaction of the OH group.

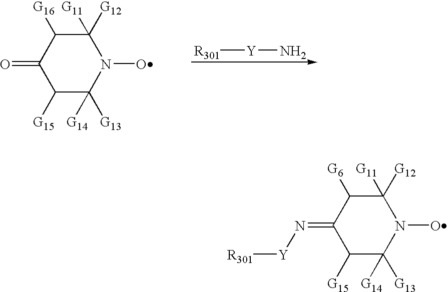

Another possible reaction scheme is to first react the 4oxonitroxide with an amine or hydrazine to yield the corresponding imine as for example described in FR 1503149.

It is, however also possible to firstly react the 4-oxopiperidine with hydroxylamine, hydrazine or with a semicarbacide to the corresponding imino-compound and oxidising the imino piperidine to the corresponding nitroxide.

The alkoxyamines of formula I may be prepared from the corresponding nitroxides as for example described in GB 2335190.

A particularly suitable process for the preparation of the compounds of formula (V) starts from the 4oxo-alkoxyamines, the preparation of which is also described in GB 2335190:

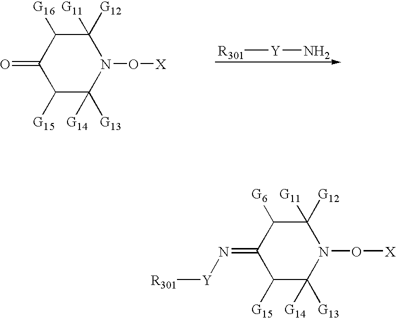

Since the 4-oxo-alkoxyamines already may have several asymmetrical carbon atoms, a variety of stereo isomers is usually obtained as mixture with different ratios of the individual isomers. It is however possible to separate the individual isomers in pure form. Mixtures of the stereo isomers as well as the pure individual isomers are within the scope of the present invention.

The alkyl radicals in the various substituents may be linear or branched. Examples of alkyl containing 1 to 18 carbon atoms are methyl, ethyl, propyl, isopropyl, butyl, 2-butyl, isobutyl, t-butyl, pentyl, 2-pentyl, hexyl, heptyl, octyl, 2-ethylhexyl, t-octyl, nonyl, decyl, undecyl, dodecyl, tridecyl, tetradecyl, hexadecyl and octadecyl.

Alkenyl with 3 to 18 carbon atoms is a linear or branched radical as for example propenyl, 2-butenyl, 3-butenyl, isobutenyl, n-2,4-pentadienyl, 3methyl-2-butenyl, n-2-octenyl, n-2-dodecenyl, iso-dodecenyl, oleyl, n-2-octadecenyl oder n-4-octadecenyl.

Preferred is alkenyl with 3 bis 12, particularly preferred with 3 to 6 carbon atoms.

Alkinyl with 3 to 18 is a linear or branched radical as for example propinyl (—CH₂—C≡CH ), 2-butinyl, 3-butinyl, n-2-octinyl, oder n-2-octadecinyl. Preferred is alkinyl with 3 to 12, particularly preferred with 3 to 6 carbon atoms.

Examples for hydroxy substituted alkyl are hydroxy propyl, hydroxy butyl or hydroxy hexyl.

Examples for halogen substituted alkyl are dichloropropyl, monobromobutyl or trichlorohexyl.

C₂-C₁₈alkyl interrupted by at least one O atom is for example —CH₂—CH₂—O—CH₂—CH₃, —CH₂—CH₂—O—CH₃— or —CH₂—CH₂—O—CH₂—CH₂—CH₂—O—CH₂—CH₃—. It is preferably derived from polyethlene glycol. A general description is —((CH₂)ₐ—O)_{b}—H/CH₃, wherein a is a number from 1 to 6 and b is a number from 2 to 10.

C₂-C₁₈alkyl interrupted by at least one NR₅ group may be generally described as —((CH₂)ₐ—NR₅)_{b}—H/CH₃, wherein a, b and R₅ are as defined above.

C₃-C₁₂cycloalkyl is typically, cyclopropyl, cyclopentyl, methylcyclopentyl, dimethylcyclopentyl, cyclohexyl, methylcyclohexyl or trimethylcyclohexyl.

C₆-C₁₀ aryl is for example phenyl or naphthyl, but also comprised are C₁-C₄alkyl substituted phenyl, C₁-C₄alkoxy substituted phenyl, hydroxy, halogen or nitro substituted phenyl. Examples for alkyl substituted phenyl are ethylbenzene, toluene, xylene and its isomers, mesitylene or isopropylbenzene. Halogen substituted phenyl is for example dichlorobenzene or bromotoluene.

Alkoxy substituents are typically methoxy, ethoxy, propoxy or butoxy and their corresponding isomers.

C₇-C₉phenylalkyl is benzyl, phenylethyl or phenylpropyl.

C₅-C₁₀-heteroaryl is for example pyrrol, pyrazol, imidazol, 2,4, dimethylpyrrol, 1-methylpyrrol, thiophene, furane, furfural, indol, cumarone, oxazol, thiazol, isoxazol, isothiazol, triazol, pyridine, α-picoline, pyridazine, pyrazine or pyrimidine.

If R is a monovalent radical of a carboxylic acid, it is, for example, an acetyl, propionyl, butyryl, valeroyl, caproyl, stearoyl, lauroyl, acryloyl, methacryloyl, benzoyl, cinnamoyl or β-(3,5-di-tert-butyl4-hydroxyphenyl)propionyl radical.

C₁-C₁₈alkanoyl is for example, formyl, propionyl, butyryl, octanoyl, dodecanoyl but preferably acetyl and C₃-C₅alkenoyl is in particular acryloyl.

In general the polymerization processes using nitroxylethers a1) or nitroxyl radicals together with a free radical initiator a2) are preferred. In particular polymerization process a1) is very suitable.

Particularly suitable nitroxylethers and nitroxyl radicals are those of formulae

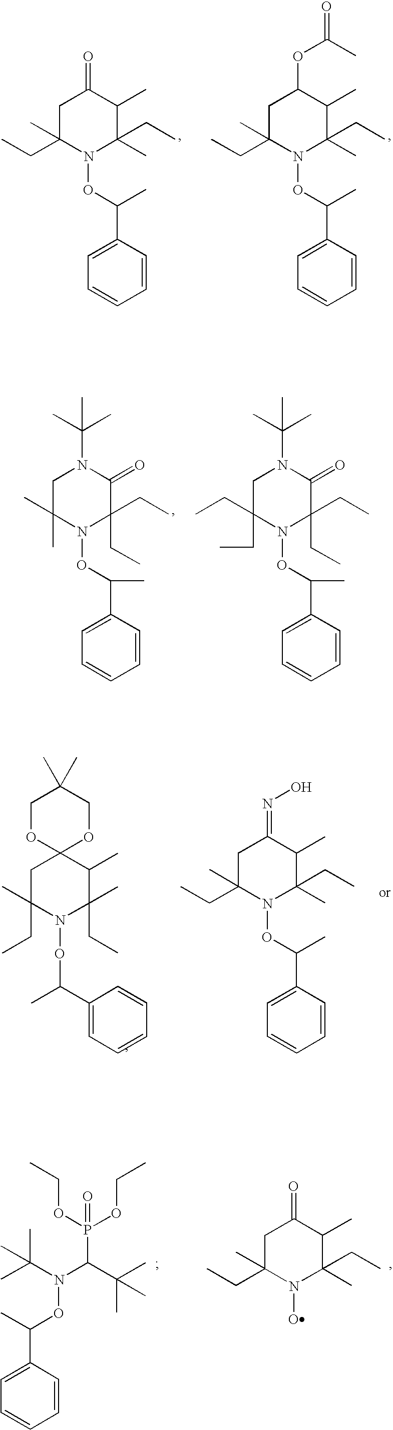

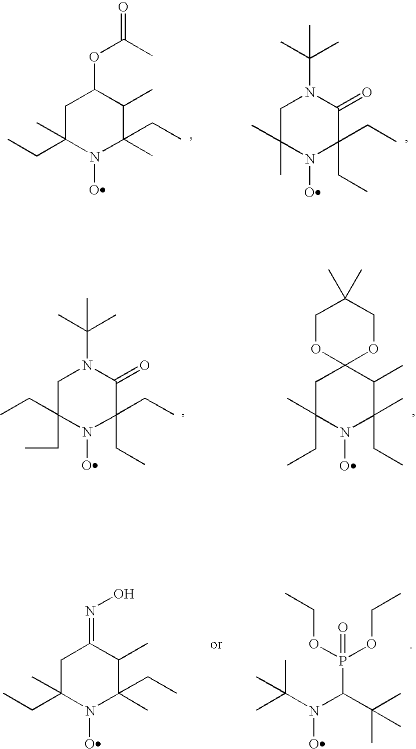

The free radical initiator of component b2) is preferably a bis-azo compound, a peroxide, perester or a hydroperoxide.

Specific preferred radical sources are 2,2′-azobisisobutyronitrile, 2,2′-azobis(2-methyl-butyronitrile), 2,2′-azobis(2,4-dimethylvaleronitrile), 2,2′-azobis(4methoxy-2,4dimethylvale-ronitrile), 1,1′-azobis(1-cyclohexanecarbonitrile), 2,2′-azobis(isobutyramide) dihydrate, 2-phenylazo-2,4dimethyl-4-methoxyvaleronitrile, dimethyl-2,2′-azobisisobutyrate, 2-(carbamoylazo)isobutyronitrile, 2,2′-azobis(2,4,4trimethylpentane), 2,2′-azobis(2-methylpropane), 2,2′-azobis(N,N′-dimethyleneisobutyramidine), free base or hydrochloride, 2,2′-azobis(2-amidinopropane), free base or hydrochloride, 2,2′-azobis{2-methyl-N-[1,1-bis(hydroxym ethyl)ethyl]propionamide} or 2,2′-azobis{2-methyl-N-[1,1-bis(hydroxymethyl)-2-hydroxyethyl]propionamide; acetyl cyclohexane sulphonyl peroxide, diisopropyl peroxy dicarbonate, t-amyl pemeodecanoate, t-butyl pemeodecanoate, t-butyl perpivalate, t-amylperpivalate, bis(2,4-dichlorobenzoyl)peroxide, diisononanoyl peroxide, didecanoyl peroxide, dioctanoyl peroxide, dilauroyl peroxide, bis (2-methylbenzoyl) peroxide, disuccinic acid peroxide, diacetyl peroxide, dibenzoyl peroxide, t-butyl per 2-ethylhexanoate, bis-(4-chlorobenzoyl)-peroxide, t-butyl perisobutyrate, t-butyl permaleinate, 1,1 -bis(t-butylperoxy)3,5,5-trimethylcyclohexane, 1,1-bis(t-butylperoxy)cyclohexane, t-butyl peroxy isopropyl carbonate, t-butyl perisononaoate, 2,5dimethylhexane 2,5-dibenzoate, t-butyl peracetate, t-amyl perbenzoate, t-butyl perbenzoate, 2,2-bis (t-butylperoxy) butane, 2,2 bis (t-butylperoxy) propane, dicumyl peroxide, 2,5-dimethylhexane-2,5-di-t-butylperoxide, 3-t-butylperoxy 3-phenylphthalide, di-t-amyl peroxide, α, α′-bis(t-butylperoxy isopropyl) benzene, 3,5-bis (t-butylperoxy)3,5-dimethyl 1,2-dioxolane, di-t-butyl peroxide, 2,5-dimethylhexyne-2,5-di-t-butylperoxid 3,3,6,6,9,9-hexamethyl 1,2,4,5-tetraoxa cyclononane, p-menthane hydroperoxide, pinane hydroperoxide, diisopropylbenzene mono-α-hydroperoxide, cumene hydroperoxide or t-butyl hydroperoxide.

A suitable component a3) contains a compound of formula

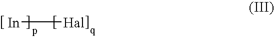

with a radically transferable atom or group •Hal as is described in WO 96/30421 and WO 98/01480. A preferred radically transferable atom or group •Hal is •Cl or •Br, which is cleaved as a radical from the initiator molecule.

Preferably [In] represents the polymerization initiator fragment of a polymerization initiator of formula

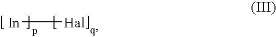

capable of initiating polymerization of monomers or oligomers which polymerization initiator is selected from the group consisting of C₁-C₈-alkyl halides, C₆-C₁₅-aralkylhalides, C₂-C₈α-haloalkyl esters, arene sulfonyl chlorides, haloalkane-nitriles, α-haloacrylates and halolactones,

p and q represent one and the other components are as defined above.

The polymerization process in the presence of a compound of formula (III) is known as ATRP (Atom Transfer Radical Polymerization) and WO 96/30421 discloses a controlled or “living” polymerization process of ethylenically unsaturated polymers such as styrene or (meth)acrylates by employing the ATRP method. According to this method initiators are employed which generate a radical atom such as •Cl, in the presence of a redox system of transition metals of different oxidation states, e.g. Cu(I) and Cu(II), providing “living” or controlled radical polymerization.

Specific initiators are selected from the group consisting of α,α′-dichloro- or α,α′-dibromoxylene, p-toluenesulfonylchloride (PTS), hexakis-(α-chloro- or α-bromomethyl)-benzene, 2-chloro- or 2-bromopropionic acid, 2-chloro- or 2-bromoisobutyric acid, 1-phenethyl chloride or bromide, methyl or ethyl 2-chloro- or 2-bromopropionate, ethyl-2-bromo- or ethyl-2-chloroisobutyrate, chloro- or bromoacetonitrile, 2-chloro- or 2-bromopropionitrile, α-bromo-benzacetonitrile and α-bromo-γ-butyrolactone (=2-bromo-dihydro-2(3H)-furanone).

The transition metal in the oxidizable transition metal complex catalyst salt used in the process of the invention is present as an oxidizable complex ion in the lower oxidation state of a redox system. Preferred examples of such redox systems are selected from the group consisting of Group V(B), VI(B), VII(B), VIII, IB and IIB elements, such as Cu⁺/Cu²⁺, Cu⁰/Cu⁺, Fe⁰/Fe²⁺, Fe²⁺/Fe³⁺, Ru²⁺/Ru³⁺, Ru³⁺/Ru⁴⁺, OS²⁺/OS³⁺, Vⁿ⁺/V⁽ⁿ⁺¹⁾⁺, Cr²⁺Cr³⁺, Co⁺/Co²⁺, Co²⁺/Co³⁺, Ni⁰/Ni⁺, Ni⁺/Ni²⁺, Ni²⁺/Ni³⁺, Mn⁰/Mn²⁺, Mn²⁺/Mn³⁺/Mn⁴⁺ or Zn⁺/Zn²⁺.

The ionic charges are counterbalanced by anionic ligands commonly known in complex chemistry of transition metals, such hydride ions (H⁻) or anions derived from inorganic or organic acids, examples being halides, e.g. F⁻, Cl⁻, Br⁻ or I⁻, fluoro complexes of the type BF₄⁻, PF₆⁻, SbF₆⁻ or AsF₆⁻, anions of oxygen acids, alcoholates or acetylides or anions of cyclopentadiene.

Anions of oxygen acids are, for example, sulfate, phosphate, perchlorate, perbromate, periodate, antimonate, arsenate, nitrate, carbonate, the anion of a C₁-C₈carboxylic acid, such as formate, acetate, propionate, butyrate, benzoate, phenylacetate, mono-, di- or trichloro- or -fluoroacetate, sulfonates, for example methylsulfonate, ethylsulfonate, propylsulfonate, butylsulfonate, trifluoromethylsulfonate (triflate), unsubstituted or C₁-C₄alkyl-, C₁-C₄alkoxy- or halo-, especially fluoro-, chloro- or bromo-substituted phenylsulfonate or benzylsulfonate, for example tosylate, mesylate, brosylate, p-methoxy- or p-ethoxyphenylsulfonate, pentafluorophenylsulfonate or 2,4,6-triisopropylsulfonate, phosphonates, for example methylphosphonate, ethylphosphonate, propylphosphonate, butylphosphonate, phenylphosphonate, p-methylphenylphosphonate or benzylphosphonate, carboxylates derived from a C₁-C₈carboxylic acid, for example formate, acetate, propionate, butyrate, benzoate, phenylacetate, mono-, di- or trichloro- or -fluoroacetate, and also C₁-C₁₂-alcoholates, such as straight chain or branched C₁-C₁₂alcoholates, e.g. methanolate or ethanolate. Anionic ligands and neutral may also be present up to the preferred coordination number of the complex cation, especially four, five or six. Additional negative charges are counterbalanced by cations, especially monovalent cations such as Na⁺, K⁺, NH₄⁺ or (C₁-C₄ alkyl)₄N⁺.

Suitable neutral ligands are inorganic or organic neutral ligands commonly known in complex chemistry of transition metals. They coordinate to the metal ion through a σ-, π-, μ, η-type bonding or any combinations thereof up to the preferred coordination number of the complex cation. Suitable inorganic ligands are selected from the group consisting of aquo (H₂O), amino, nitrogen, carbon monoxide and nitrosyl. Suitable organic ligands are selected from the group consisting of phosphines, e.g. (C₆H₅)₃P, (i-C₃H₇)₃P, (C₅H₉)₃P or (C₆H₁₁)₃P, di-, tri, tetra- and hydroxyamines, such as ethylenediamine, ethylenediaminotetraacetate (EDTA), N,N-Dimethyl-N′,N′-bis(2-dimethylaminoethyl)-ethylenediamine (Me₆TREN), catechol, N,N′-dimethyl-1,2-benzenediamine, 2-(methylamino)phenol, 3-(methylamino)-2-butanol or N,N′-bis(1,1-dimethylethyl)-1,2-ethanediamine, N,N,N′,N″,N″-pentamethyidiethyltriamine (PMD-ETA), C₁-C₈-glycols or glycerides, e.g. ethylene or propylene glycol or derivatives thereof, e.g. di-, tri- or tetraglyme, and monodentate or bidentate heterocyclic e⁻ donor ligands.

Heterocyclic e⁻ donor ligands are derived, for example, from unsubstituted or substituted heteroarenes from the group consisting of furan, thiophene, pyrrole, pyridine, bis-pyridine, picolylimine, g-pyran, g-thiopyran, phenanthroline, pyrimidine, bis-pyrimidine, pyrazine, indole, coumarone, thionaphthene, carbazole, dibenzofuran, dibenzothiophene, pyrazole, imidazole, benzimidazole, oxazole, thiazole, bis-thiazole, isoxazole, isothiazole, quinoline, bis-quinoline, isoquinoline, bis-isoquinoline, acridine, chromene, phenazine, phenoxazine, phenothiazine, triazine, thianthrene, purine, bis-imidazole and bis-oxazole.

The oxidizable transition metal complex catalyst can be formed in a separate preliminary reaction step from its ligands or is preferably formed in-situ from its transition metal salt, e.g. Cu(I)Cl, which is then converted to the complex compound by addition of compounds corresponding to the ligands present in the complex catalyst, e.g. by addition of ethylenediamine, EDTA, Me₆TREN or PMDETA.

Preferred is a composition, wherein in the component b3) the oxidizable transition metal in the transition metal complex salt is present as a transition metal complex ion in the lower oxidation state of a redox system.

More preferred is a composition, wherein the transition metal complex ion is a Cu(I) complex ion in the Cu(I)/Cu(II) system.

It is also possible to carry out the first step as an anionic polymerization (reaction a4). Anionic polymerizations are known and for example described in Encyclopedia of Polymer Science and Technology, vol. 2,1964, 95-137.

The anionic polymerization is for example carried out in an appropriate organic solvent in the presence of an organic alkali metal compound and/or an alkali metal as a polymerzation initiator at a temperature of −100° C. to 150° C. in the atomosphere of an inert gas such as nitrogen or argon.

Examples of polymerization initiators include alkali metals such as lithium, sodium and potassium; and/or organic alkali metal compounds such as ethyl lithium, n-butyl lithium, sec-butyl lithium, tert-butyl lithium, butadienyl dilithium, butadienyl disodium, lithium biphenylide, sodium biphenylide, lithium di-tert-butylbiphenylide, sodium di-tert-butylbiphenylide, lithium naphthalenide, sodium naphthalenide, lithium triphenylide, sodium triphenylide, α-methylstyrenesodium anion radical, 1,1-diphenyl hexyl lithium, and 1,1-diphenyl-3-methylpentyl lithium.

The polymerization is typically carried out in a solvent. Solvents are, for example, aliphatic hydrocarbons such as n-hexane and n-heptane; allcyclic hydrocarbons such as cyclohexane and cyclopentane; aromatic hydrocarbons such as benzene and toluene; aliphatic ethers such as diethyl ether; cyclic ethers such as tetrahedrofuran and dioxane; and the like.

The polymerization process according to step a1) is in general preferred.

A very suitable process is, wherein the nitroxyl ether of formula

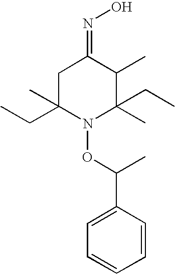

is used in the polymerization step a1).

Preferably the optionally used additional ethylenically unsaturated monomer is selected from the group consisting of an acrylic acid ester, acrylamide, acryinitrile, methacrylic acid ester, methacrylamide, methacrylnitrile and styrene.

Acrylic acid esters and methacrylic acid esters are typically C₁-C₁₈alkyl esters.

Such an additional monomer is preferably used in an amount of 1 part to 30 parts based on 100 parts of hydroxy functional vinyl aromatic monomer.

Most preferred is n-butylacrylate, tert-butylacrylate, methylacrylate, ethylacrylate, propylacrylate, hexylacrylate, hydroxyethylacrylate and styrene.

Preferably the nitroxylether of component a1) or the nitroxyl radical of component a2) is present in an amount of from 0.001 mol-% to 20 mol-%, more preferably of from 0.002 mol-% to 10 mol-% and most preferably of from 0.005 mol-% to 5 mol-% based on the monomer or monomer mixture.

Preferably the free radical initiator is present in an amount of 0.001 mol-% to 20 mol-%, based on the monomer or monomer mixture.

The molar ratio of free radical initiator to stable free nitroxyl radical is preferably from 20:1 to 1:2, more preferably from 10:1 to 1:2.

Scission of the O—X bond of the nitroxylether may be effected by ultrasonic treatment, radiation with actinic light or heating.

The scission of the O—X bond is preferably effected by heating and takes place at a temperature of between 50° C. and 180° C., more preferably from 90° C. to 150° C.

The polymerization reaction is carried out with preference under atmospheric pressure.

Preferably the hydroxy-vinyl aromatic oligomer, cooligomer, polymer or copolymer has a weight molecular weight average from 2000 to 30 000 Daltons.

Preferably the hydroxy-vinyl aromatic oligomer, cooligomer, polymer or copolymer has a polydispersity M_{w}/Mₙ of between 1.1 and 1.8, in particular between 1.1 and 1.6.

After the polymerization step is completed the reaction mixture may be cooled down to a temperature below 60° C., preferably to room temperature. The polymer may be stored at this temperature without further reactions occurring.

The radical polymerization process may be carried out in bulk, in the presence of an organic solvent or in the presence of water or in mixtures of organic solvents and water. Additional cosolvents or surfactants, such as glycols or ammonium salts of fatty acids, may be present. Other suitable cosolvents are described hereinafter.

If organic solvents are used, suitable solvents or mixtures of solvents are typically pure alkanes (hexane, heptane, octane, isooctane), aromatic hydrocarbons (benzene, toluene, xylene), halogenated hydrocarbons (chlorobenzene), alkanols (methanol, ethanol, ethylene glycol, ethylene glycol moriomethyl ether), esters (ethyl acetate, propyl, butyl or hexyl acetate) and ethers (diethyl ether, dibutyl ether, ethylene glycol dimethyl ether), anisol, or mixtures thereof.

The aqueous polymerization reactions can be supplemented with a water-miscible or hydrophilic cosolvent to help ensure that the reaction mixture remains a homogeneous single phase throughout the monomer conversion. Any water-soluble or water-miscible cosolvent may be used, as long as the aqueous solvent medium is effective in providing a solvent system which prevents precipitation or phase separation of the reactants or polymer products until after all polymerization reactions have been completed. Exemplary cosolvents useful in the present invention may be selected from the group consisting of aliphatic alcohols, glycols, ethers, glycol ethers, pyrrolidines, N-alkyl pyrrolidinones, N-alkyl pyrrolidones, polyethylene glycols, polypropylene glycols, amides, carboxylic acids and salts thereof, esters, organosulfides, sulfoxides, sulfones, alcohol derivatives, hydroxyether derivatives such as butyl carbitol or cellosolve, amino alcohols, ketones, and the like, as well as derivatives thereof and mixtures thereof. Specific examples include methanol, ethanol, propanol, dioxane, ethylene glycol, propylene glycol, diethylene glycol, glycerol, dipropylene glycol, tetrahydrofuran, and other water-soluble or water-miscible materials, and mixtures thereof. When mixtures of water and water-soluble or water-miscible organic liquids are selected as the aqueous reaction media, the water to cosolvent weight ratio is typically in the range of about 100:0 to about 10:90.

Hydrogenation can be carried out for example by transfer hydrogenation in the presence of a metal catalyst with cyclohexene, ammonium formate, hydrazine and the like, as for example described in Chem. Rev. 85,129 (1985).

Preferably the hydrogenation reaction is carried in the presence of hydrogen and a metal catalyst.

Preferred metal catalysts are Pt, Pd, Ru, Rh or Raney-Ni.

The hydrogenation step is carried out by methods known per se. The hydrogenation may be carried out, for example, continuously over a nickel catalyst. The product to be hydrogenated does not have to be purified beforehand. Such continuous hydrogenation processes are known to the skilled person and are described in “Katalytische Hydrierungen im organisch-chemischen Laboratorium, F. Zymalkowski, 1965, Ferdinand Enke Verlag Stuttgart”.

Continuous hydrogenations over nickel catalysts are typically carried out in the temperature range from about 90-150° C., nickel skeleton catalysts usually being used (Ni on Al₂O₃ or e.g. SiO₂ substrates). The yield is normally very high and is usually from 96-98%.

It is also possible to carry out the hydrogenation batchwise, for example in the presence of a Pd/C or Pt/C catalyst. Such hydrogenation processes are also known to the skilled person and are described, inter alia, in “Hydrogenation Methods, Paul N. Rylander, 1985, Academic Press”.

Typical process parameters in the case of batchwise hydrogenation are temperatures in the range from 30-100° C. and a hydrogen pressure of about 50 bar, Pd- or Pt-catalysts usually being used which are normally bound to carrier materials. The ratio of educt to catalyst is usually from 50-1000 g/g.

The hydroxy-vinyl-aromatic polymer with low polydispersity prepared according to the present invention is particularly useful as binder material for negative or positive working photoresists. It's main use however is in positive photo resists. The formulation of such resists is known to those skilled in the art and for example described in EP 813 113.

The following examples illustrate the invention.

### Preparation of 2,6-Diethyl-2,3,6-trimethyl-1-(1-phenyl-ethoxy)-piperidine-4-one oxime

2,6-diethyl-2,3,6-trimethyl-1-(1-phenyl-ethoxy)-4-oxopiperidine prepared according to DE 199 09 767 A1 is dissolved in methanol containing 10% by weight of KOH and stirred for 5 hours at room temperature. Methanol is evaporated, the residue is washed with water and dried in vacuo. A solution of 95.24 g (0.3 mol) of 2,6-diethyl-2,3,6-trimethyl-1-(1-phenyl-ethoxy)-4-oxopiperidine and 29.7 g (0.45 mol) 50% aqueous hydroxylamine solution in 150 ml of methanol is stirred under reflux during 5 h. The suspension is then cooled to −8° C. and filtered. The solid is washed with 100 ml of a cold (−20° C.) methanol and dried to afford 64 g (64.1%) of the title compound as a white, microcrystalline powder, mp 130-145° C. C₂₀H₃₂N₂O₂ (332.49) calculated C, 72.25%, H, 9.70%, N, 8.43%; found 72.19% C, 9.54% H, 8.43% N.

A) Preparation of Polymers

### EXAMPLE A1

4-Benzyloxystyrene (94.6 g, 450 mmol) and 2,6-diethyl-2,3,6-trimethyl-1-(1-phenyl-ethoxy)-piperidin-4-one oxime (1.50 g, 4.50 mmol) are placed in a 1.0 L round bottom flask. After degassing, the mixture is heated to 130° C. and stirred for 6h under Ar. The reaction mixture is cooled down to room temperature and dissolved in CH₂Cl₂ (120 mL) and subsequently precipitated in MeOH (1.5 L). The precipitation is repeated twice, and 68.1 g of a white solid are obtained after drying in a vacuum oven overnight. GPC analysis using tetrahydrofurane (THF) as mobile phase and calibration with polystyrene standard shows Mn=9787, Mw/Mn=1.17. ¹H NMR (CDCl3): 0.7-2.4 (br m, 3H), 4.9 (br s, 2H), 6.0-6.9 (br m, 4H), 6.9-7.6 (br m, 5H).

### EXAMPLE A2

4-Benzyloxystyrene (10.5 g, 50.0 mmol), 2,6diethyl-2,3,6-trimethyl-1-(1-phenyl-ethoxy)-piperidin-4-one oxime (0.333 g, 1.00 mmol) and 1.17 g of anisole are placed in a 100 mL schlenk tube and degassed, followed by purging with Ar. The mixture is heated to 130° C. and stirred for 18 h under Ar. Then, the reaction mixture is cooled down to room temperature and dissolved in CH₂Cl₂ (15 mL). The polymer is precipitated in MeOH (300 mL) and washed with MeOH. This precipitation is repeated twice, and 7.58 g of pale yellow solid are obtained after drying in a vacuum oven overnight. GPC analysis shows Mn=4003, Mw/Mn=1.65.

### EXAMPLE A3

4-Benzyloxystyrene (10.5 g, 50.0 mmol) and 2,6-diethyl-2,3,6-trimethyl-1-(1-phenyl-ethoxy)-piperidin-4-one oxime (0.223 g, 0.667 mmol) are placed in a 100 mL sshlenk tube and degassed, followed by purging with Ar. The mixture is heated to 130° C. and stirred for 6 h under Ar. The polymer is isolated as described in example A1. 7.17 g of the polymer are obtained. GPC analysis shows Mn=7723, Mw/Mn=1.19.

### EXAMPLE A4

4-Benzyloxystyrene (10.5 g, 50.0 mmol) and 1-.tert.-butyl-3,3-diethyl-5,5-dimethyl-4-(1-phenyl-ethoxy)-piperazin-2-one, prepared according to GB 2342649 (0.180 g, 0.50 mmol) are placed in a 100 mL sshlenk tube and degassed, followed by purging with Ar. The mixture is heated to 145° C. and stirred for 5 h under Ar. The polymer is isolated as described in example A1. 4.28 g of the polymer are obtained. GPC analysis shows Mn=5547, Mw/Mn=1.35.

### EXAMPLE A5

4-Benzyloxystyrene (10.5 g, 50.0 mmol) and 2,6-diethyl-2,3,6-trimethyl-1-(1-phenyl-ethoxy)-piperidin-4-ol, prepared according to GB 2335190, (0.160 g, 0.50 mmol) are placed in a 100 mL schlenk tube and degassed, followed by purging with Ar. The mixture is heated to 110° C. and stirred for 24 h under Ar. The polymer is isolated as described in example A1. 6.10 g of the polymer are obtained. GPC analysis shows Mn=8064, Mw/Mn=1.27.

### EXAMPLE A6

4-Benzyloxystyrene (10.5 g, 50.0 mmol), 2,7-diethyl-2,3,7-trimethyl-1-(1-phenyl-ethoxy)-[1,4]diazepan-5-one, prepared according to GB 2342649 (0.167 g, 0.50 mmol) are placed in a 100 mL schlenk tube and degassed, followed by purging with Ar. The mixture is heated to 110° C. and stirred for 18 h under Ar. The polymer is isolated as described in example A1. 8.49 g of the polymer are obtained. GPC analysis shows Mn=11991, Mw/Mn=1.14.

### EXAMPLE A7

4-Benzyloxycarbonyloxystyrene (12.7 g, 50.0 mmol) and 2,6-diethyl-2,3,6-trimethyl-1-(1-phenyl-etoxy)-piperidin-4-one oxime (0.166 g, 0.50 mmol) are placed in a 100 mL schlenk tube and degassed, followed by purging with Ar. The mixture is heated to 130° C. and stirred for 6 h under Ar. The polymer is isolated as described in example A1. 7.05 g of the polymer are obtained. GPC analysis shows Mn=8615, Mw/Mn=1.42.

### EXAMPLE A8

4-(α-Methyl)benzyloxystyrene (11.2 g, 50.0 mmol) and 2,6-diethyl-2,3,6-trimethyl-1-(1-phenyl-ethoxy)-piperidin-4-one one oxime (0.169 g, 0.51 mmol) are placed in a 100 mL schlenk tube and degassed, followed by purging with Ar. The mixture is heated to 130° C. and stirred for 6 h under Ar. The polymer is isolated as described in example A1. 7.50 g of the polymer are obtained. GPC analysis shows Mn=10462, Mw/Mn=1.19.

### EXAMPLE A9

4-(o,o-Dichloro)benzyloxystyrene (13.99 g, 50.1 mmol) and 2,6-diethyl-2,3,6-trimethyl-1-(1-phenyl-ethoxy)piperidin-4-one oxime (0.168 g, 0.51 mmol) are placed in a 100 mL schlenk tube and degassed, followed by purging with Ar. The mixture is heated to 130° C. and stirred for 6 h under Ar. The polymer is isolated as described in example A1. 11.85 g of the polymer are obtained. GPC analysis shows Mn=13374, Mw/Mn=1.38.

B) Debenzylation of Poly(4-benzyloxystyrene)

### EXAMPLE B1

10.0 g of poly(4-benzyloxystyrene), prepared in example A1, 200 mg of 10% Pd—C catalyst and 300 mL of THF are placed in a 100 mL steel autoclave. The autoclave is sealed and 4 consecutive cycles of nitrogen/vacuum are applied, followed by 4 consecutive cycles of hydrogen/vacuum. Then, the autoclave is pressurized to 25 bar of hydrogen, heated to 100° C. and stirred for 17 h. After releasing the pressure, the catalyst is filtered off and washed with THF. After condensation, 7.0 g of the crude polymer are obtained. 2.0 g of the crude polymer is dissolved in acetone (10 mL) and precipitated in CH₂Cl₂/hexane (1:1, 200 mL), followed by washing with this solvent mixture. 1.76 g of a white solid are obtained after drying in a vacuum oven overnight. GPC analysis using DMF including LiBr as mobile phase and calibration with polystyrene standard shows Mn=23658, Mw/Mn=1.19. ¹H NMR shows the disappearance of the benzylic protons. Transmittance at 248 nm of the polymer is 72% in THF at 0.1 g/L concentration (cell length: 1 cm). ¹H NMR (DMSO-d6): 0.6-2.0 (br m, 3H), 5.9-6.8 (br m, 4H), 9.0 (br s, 1H).

### EXAMPLE B2

5.45 g of poly(4-benzyloxystyrene), prepared in example A2, 120 mg of 10% Pd—C catalyst and 50 mL of MeOH are placed in the autoclave and set up as described in example B1. The autoclave is pressurized to 25 bar of hydrogen, heated to 160° C. and stirred for 16 h. After filtering off the catalyst and washing with MeOH. 3.62 g of the crude polymer are obtained. The same precipitation as described in example B1 yielded 2.50 9 of the polymer. GPC analysis shows Mn=14955, Mw/Mn=1.30.

### EXAMPLE B3

0.524 g of poly(4-benzyloxystyrene), prepared in example A3, 20.8 mg of 10% Pd—C catalyst, 10 mL of THF and 5 mL of MeOH are placed in a 50 mL round-bottom flask. To this solution is added 1.21 g of ammonium formate, and the mixture is heated to 65° C. and stirred for 16 h. The catalyst is filtered off and washed with THF. After condensation, the crude polymer is dissolved in MeOH (4 mL) and precipitated in H₂O (40 mL), followed by washing with H₂O. 0.257 g of a white solid is obtained after drying in a vacuum oven overnight. GPC analysis shows Mn=27055, Mw/Mn=1.15.

### EXAMPLE B4

0.507 g of poly(4-benzyloxystyrene), prepared in example A3, 19.9 mg of 10% Pd—C catalyst and 10 mL of acetone are placed in a 50 mL round-bottom flask. To this solution is added 1.019 of ammonium formate, and the mixture is heated to reflux and stirred for 9.5 h. The catalyst is filtered off and washed with acetone. After condensation, the crude polymer is dissolved in MeOH (5 mL) and precipitated in H₂O (50 mL), followed by washing with H₂O. 0.286 g of a white solid is obtained after drying in a vacuum oven overnight. GPC analysis shows Mn=23451, Mw/Mn=1.26.

1. A process for the preparation of a narrow molecular weight distributed hydroxy-vinyl aromatic oligomer, cooligomer, polymer or copolymer with a polydispersity M_{w}/Mₙ between 1 and 2, which process comprises the steps reacting a composition of at least one monomer of formula I 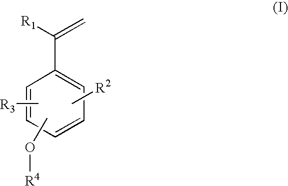
wherein
R₁ is H or CH₃;
R₂ and R₃ are independently C₁-C₈alkyl, C₁-C₈alkoxy, C₁-C₈alkoxycarbonyl, C₁-C₈alkylthio,
C₁-C₈dialkylamino, trihalogenmethyl;
R₄ is benzyl which is unsubstituted or substituted with one or two C₁-C₈alkyl, C₁-C₈alkoxy, C₁-C₈alkoxycarbonyl, C₁-C₈alkylthio, C₁-C₈dialkylamino, trihalogenmethyl, halogen; or R₄ is a group (phenyl)(methyl)CH—, (phenyl)₂CH— or phenyl-CH₂—O—C(O)—;
a1) in the presence of at least one nitroxylether having the structural element 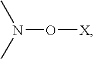
wherein X represents a group having at least one carbon atom and is such that the free radical X• derived from X is capable of initiating polymerization of ethylenically unsaturated monomers; or
a2) in the presence of at least one stable free nitroxyl radical 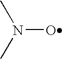
and a free radical initiator; or
a3) in the presence of a compound of formula 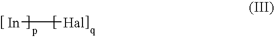
and a catalytically effective amount of an oxidizable transition metal complex catalyst, wherein
p represents a number greater than zero and defines the number of initiator fragments;
q represents a number greater than zero;
[In] represents a radically transferable atom or group capable of initiating polymerization and
—[Hall] represents a leaving group; or
a4) in an anionic polymerization reaction in the presence of a metal or organo metal catalyst;
and optionally simultaneously or in a subsequent step with one or more ethylenically unsaturated monomers different from those of formula (I); and
b) isolating the resulting polymer and subjecting it to a hydrogenation reaction giving a polymer with repeating units of formula II 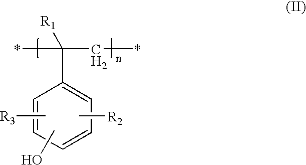
and with a degree of OH-groups of between 10 mol % and 100 mol %, based on the molar amount of protected hydroxy-vinyl aromatic monomer of formula 1.

2. A process according to claim 1 for the preparation of a narrow molecular weight distributed hydroxy-vinyl aromatic oligomer, cooligomer, polymer or copolymer with a polydispersity M_{w}/Mₙ between 1 and 2, which process comprises the steps reacting a composition of at least one monomer of formula I 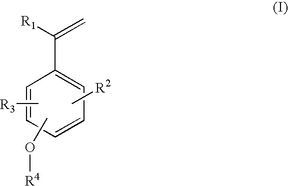
wherein
R₁ is H or CH₃;
R₂ and R₃ are independently C₁-C₈alkyl, C₁-C₈alkoxy, C₁-C₈alkoxycarbonyl, C₁-C₈alkylthio, C₁-C₈dialkylamino, trihalogenmethyl;
R₄ is benzyl which is unsubstituted or substituted with one or two C₁-C₈alkyl, C₁-C₈alkoxy, C₁-C₈alkoxycarbonyl, C₁-C₈alkylthio, C₁-C₈dialkylamino, trihalogenmethyl, halogen; or R₄ is a group (phenyl)(methyl)CH—, (phenyl)₂CH— or phenyl-CH₂—O—C(O)—;
a1) in the presence of at least one nitroxylether having the structural element 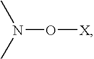
wherein X represents a group having at least one carbon atom and is such that the free radical X• derived from X is capable of initiating polymerization of ethylenically unsaturated monomers; or
a2) in the presence of at least one stable free nitroxyl radical 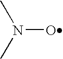
and a free radical initiator; or
a3) in the presence of a compound of formula 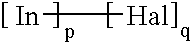
and a catalytically effective amount of an oxidizable transition metal complex catalyst, wherein
p represents a number greater than zero and defines the number of initiator fragments;
q represents a number greater than zero;
[In] represents a radically transferable atom or group capable of initiating polymerization and
—[Hall] represents a leaving group;
and optionally simultaneously or in a subsequent step with one or more ethylenically unsaturated monomers different from those of formula (I);
and
b) isolating the resulting polymer and subjecting it to a hydrogenation reaction giving a polymer with repeating units of formula II 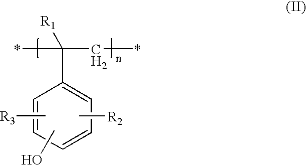
and with a degree of OH-groups of between 10 mol % and 100 mol %, based on the molar amount of protected hydroxy-vinyl aromatic monomer of formula I.

3. A process according to claim 1 wherein in formula I
R₁ is H;
R₂ and R₃ are H;
OR₄ is in the 4-position and
R₄ is benzyl or a group (phenyl)₂CH— or phenyl-CH₂—O—C(O)—.

4. A process according to claim 1, wherein component a1) is of formula A, B or O, 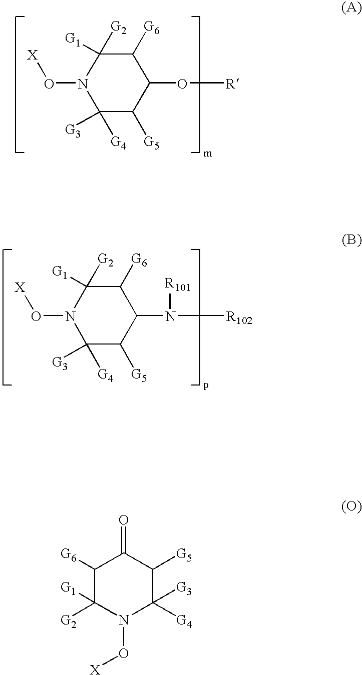
wherein
m is 1,
R is hydrogen, C₁-C₁₈alkyl which is uninterrupted or interrupted by one or more oxygen atoms, cyanoethyl, benzoyl, glycidyl, a monovalent radical of an aliphatic carboxylic acid having 2 to 18 carbon atoms, of a cycloaliphatic carboxylic acid having 7 to 15 carbon atoms, or an α,βunsaturated carboxylic acid having 3 to 5 carbon atoms or of an aromatic carboxylic acid having 7 to 15 carbon atoms;
p is 1;
R₁₀₁ is C₁-C₁₂alkyl, C₅-C₇cycloalkyl, C₇-C₈aralkyl, C₂-C₁₈alkanoyl, C₃-C₅alkenoyl or benzoyl;
R₁₀₂ is C₁-C₁₈alkyl, C₅-C₇cycloalkyl, C₂-C₈alkenyl unsubstituted or substituted by a cyano, carbonyl or carbamide group, or is glycidyl, a group of the formula —CH₂CH(OH)—Z or of the formula —CO—Z or —CONH—Z wherein Z is hydrogen, methyl or phenyl;
G₆ is hydrogen and G₅ is hydrogen or C₁-C₄alkyl,
G₁ and G₃ are methyl and G₂ and G₄ are ethyl or propyl or G₁ and G₂ are methyl and G₃ and
G₄ are ethyl or propyl; and
X is selected from the group consisting of —CH₂-phenyl, CH₃CH-phenyl, (CH₃)₂C-phenyl, (C₅-C₆cycloalkyl)₂CCN, (CH₃)₂CCN, 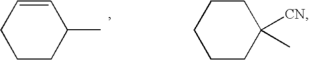
—CH₂CH═CH₂, CH₃CH—CH═CH₂(C₁-C₄alkyl)CR₂₀—C(O)-phenyl, (C₁-C₄)alkyl-CR₂₀—C(O)—(C₁-C₄)alkoxy, (C₁-C₄)alkyl-CR₂₀—C(O)—(C₁-C₄)alkyl, (C₁-C₄)alkyl-CR₂₀—C(O)—N-di(C₁-C₄)alkyl, (C₁-C₄)alkyl-CR₂₀—C(O)—NH(C₁-C₄)alkyl, (C₁-C₄)alkyl-CR₂₀—C(O)—NH₂, wherein
R₂₀ is hydrogen or (C₁-C₄)alkyl.

5. A process according to claim 1, wherein component a1) is of formula (Ic), (Id), (Ie), (If), (Ig) or (Ih) 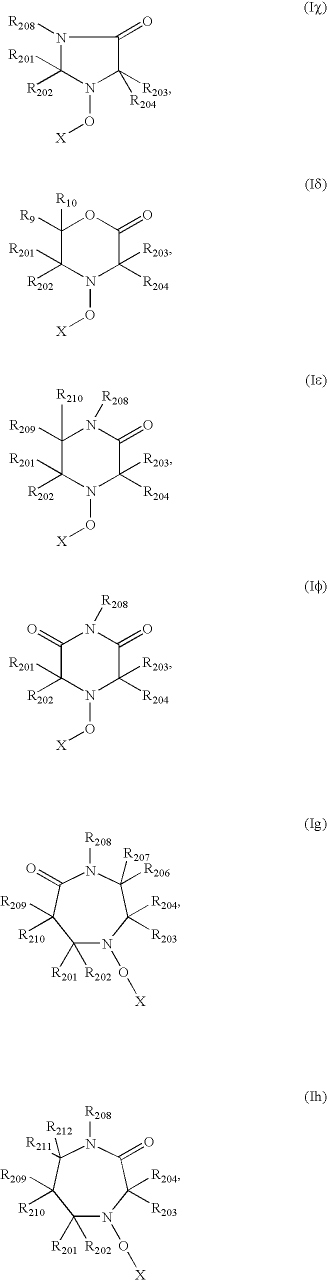
wherein R₂₀₁, R₂₀₂, R₂₀₃ and R₂₀₄ independently of each other are C₁-C₁₈alkyl, C₃-C₁₈alkenyl, C₃-C₁₈alkinyl, C₁-C₁₈alkyl, C₃-C₁₈alkenyl, C₃-C₁₈alkinyl which are substituted by OH, halogen or a group —O—C(O)—R₂₀₅, C₂-C₁₈alkyl which is interrupted by at least one O atom and/or NR₂₀₅ group, C₃-C₁₂cycloalkyl or C₆-C₁₀aryl or R₂₀₁ and R₂₀₂ and/or R₂₀₃ and R₂₀₄ together with the linking carbon atom form a C₃-C₁₂cycloalkyl radical;
R₂₀₅, R₂₀₆ and R₂₀₇ independently are hydrogen, C₁-C₁₈alkyl or C₆-C₁₀aryl;
R₂₀₈ is hydrogen, OH, C₁-C₁₈alkyl, C₃-C₁₈alkenyl, C₃-C₁₈alkinyl, C₁-C₈alkyl, C₃-C₁₈alkenyl, C₃-C₁₈alkinyl which are substituted by one or more OH, halogen or a group —O—C(O)—R₂₀₅, C₂-C₁₈alkyl which is interrupted by at least one O atom and/or NR₂₀₅ group, C₃-C₁₂cycloalkyl or C₆-C₁₀aryl, C₇-C₉phenylalkyl, C₅-C₁₀heteroaryl, —C(O)—C₁-C₁₈alkyl,—O—C₁-C₁₈alkyl or —COOC₁-C₁₈alkyl;
R₂₀₉, R₂₁₀, R₂₁₁, and R₂₁₂ are independently hydrogen, phenyl or C₁-C₁₈alkyl; and
X is selected from the group consisting of —CH₂-phenyl, CH₃CH-phenyl, (CH₃)₂C-phenyl, (C₅-C₆cycloalkyl)₂CCN, (CH₃)₂CCN, 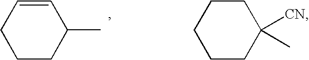
—CH₂CH═CH₂, CH₃CH—CH═CH₂ (C₁-C₄alkyl)CR₂₀—C(O)-phenyl, (C₁-C₄)alkyl-CR₂₀—C(O)—(C₁-C₄)alkoxy, (C₁-C₄)alkyl-CR₂₀—C(O)—(C₁-C₄)alkyl, (C₁-C₄)alkyl-CR₂₀—C(O)—N-di(C₁-C₄)alkyl, (C₁-C₄)alkyl-CR₂₀—C(O)—NH(C₁-C₄)alkyl, (C₁-C₄)alkyl-CR₂₀—C(O)—NH₂, wherein
R₂₀ is hydrogen or (C₁-C₄)alkyl.

6. A process according to claim 1, wherein the nitroxyl radical of component a2) is of formula A′, B′or O′, 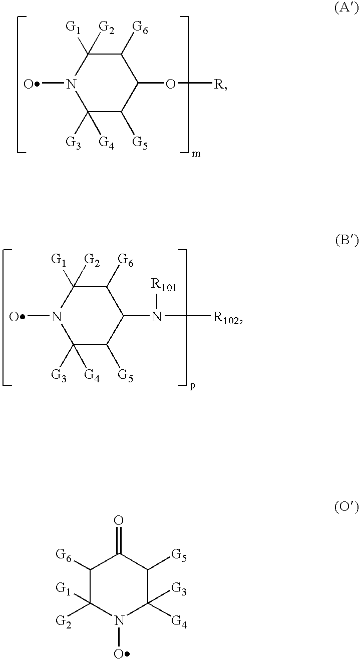
wherein
m is 1,
R is h ydrogen, C₁-C₁₈alkyl which is uninterrupted or interrupted by one or more oxygen atoms, cyanoethyl, benzoyl, glycidyl, a monovalent radical of an aliphatic carboxylic acid having 2 to 18 carbon atoms, of a cycloaliphatic carboxylic acid having 7 to 15 carbon atoms, or an α,β-unsaturated carboxylic acid having 3 to 5 carbon atoms or of an aromatic carboxylic acid having 7 to 15 carbon atoms;
p is 1;
R₁₀₁ is C₁-C₁₂alkyl, C₅-C₇cycloalkyl, C₇-C₈aralkyl, C₂-C₁₈alkanoyl, C₃-C₅alkenoyl or benzoyl;
R₁₀₂ is C₁-C₁₈alkyl, C₅-C₇cycloalkyl, C₂-C₈alkenyl unsubstituted or substituted bya cyano, carbonyl or carbamide group, or is glycidyl, a group of the formula —CH₂CH(OH)—Z or of the formula —CO—Z or —CONH—Z wherein Z is hydrogen, methyl or phenyl;
G₆ is hydrogen and G₅is hydrogen or C₁-C₄alkyl, and
G₁ and G₃ are methyl and G₂ and G₄ are ethyl or propyl or G₁ and G₂ are methyl and G₃ and
G₄ are ethyl or propyl.

7. A process according to claim 1, wherein the nitroxyl radical of component a2) is of formula (Ic′), (Id′), (Ie′), (If′), (Ig′) or (Ih′) 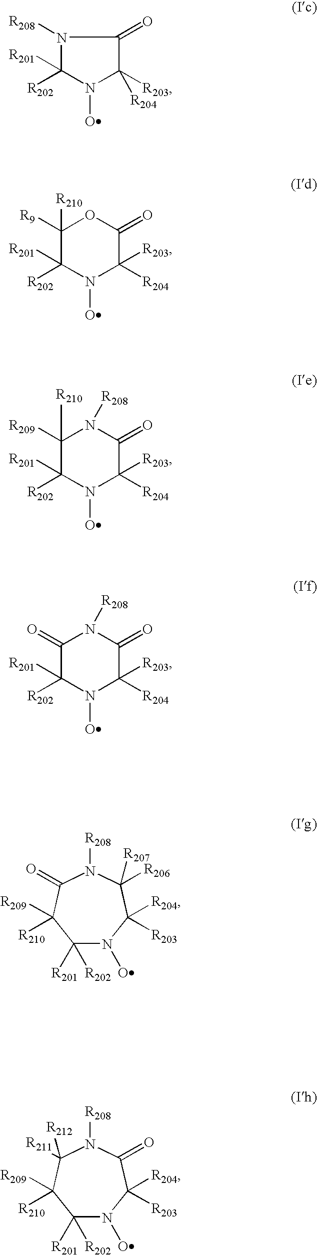
wherein R₂₀₁, R₂₀₂, R₂₀₃ and R₂₀₄ independently of each other are C₁-C₁₈alkyl, C₃-C₁₈alkenyl, C₃-C₁₈alkinyl, C₁-C₁₈alkyl, C₃-C₁₈alkenyl, C₃-C₁₈alkinyl which are substituted by OH, halogen or a group —O—C(O)—R₂₀₅, C₂-C₁₈alkyl which is interrupted by at least one O atom and/or NR₂₀₅ group, C₃-C₁₂cycloalkyl or C₆-C₁₀aryl or R₂₀₁ and R₂₀₂ and/or R₂₀₃ and R₂₀₄ together with the linking carbon atom form a C₃-C₁₂cycloalkyl radical;
R₂₀₅, R₂₀₆ and R₂₀₇ independently are hydrogen, C₁-C₁₈alkyl or C₆-C₁₀aryl;
R₂₀₈ is hydrogen, OH, C₁-C₁₈alkyl, C₃-C₁₈alkenyl, C₃-C₁₈alkinyl, C₁-C₁₈alkyl, C₃-C₁₈alkinyl which are substituted by one or more OH, halogen or a group —O—C(O)—R₂₀₅, C₂-C₁₈alkyl which is interrupted by at least one O atom and/or NR₂₀₅ group, C₃-C₁₂cycloalkyl or C₆-C₁₀aryl, C₇-C₉phenylalkyl, C₅-C₁₀heteroaryl, —C(O)—C₁-C₁₈alkyl, —O—C₁-C₁₈alkyl or —COOC₁-C₁₈alkyl; and
R₂₀₉, R₂₁₀, R₂₁₁, and R₂₁₂ are independently hydrogen, phenyl or C₁-C₁₈alkyl.

8. A process according to claim 1, wherein in the component a3)
[In] represents the polymerization initiator fragment of a polymerization initiator of formula (III) capable of initiating polymerization of monomers or oligomers which polymerization initiator is selected from the group consisting of C₁-C₈-alkyl halides, C₈-C₁₅-aralkylhalides, C₂-C₈-haloalkyl esters, arene sulfonyl chlorides, haloalkanenitriles, α-haloacrylates and halolactones,
p and q represent one and the other components are as defined in claim 1.

9. A process according to claim 1, wherein in the component a3) the oxidizable transition metal in the transition metal complex salt is present as a transition metal complex ion in the lower oxidation state of a redox system.

10. A process according to claim 9, wherein the transition metal complex ion is a Cu(I) complex ion in the Cu(I)/Cu(II) system.

11. A process according to claim 1 wherein the nitroxyl ether of formula 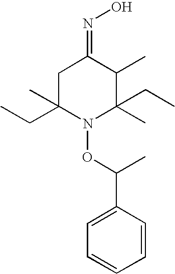
is used in the polymerization step a1).

12. A process according to claim 1 wherein the optionally used additional ethylenically unsaturated monomer is selected from the group consisting of an acrylic acid ester, acrylamide, acryinitrile, methacrylic acid ester, methacrylamide, methacrylnitrile and styrene.

13. A process according to claim 1 wherein the polymerization temperature is between 90° C. and 150° C.

14. A process according to claim 1 wherein the hydroxy-vinyl aromatic oligomer, cooligomer, polymer or copolymer has a weight molecular weight average from 2000 to 30 000 Daltons.

15. A process according to claim 1 wherein the hydrogenation reaction is carried out in the presence of hydrogen and a metal catalyst.

16. A process according to claim 15 wherein Pt, Pd, Ru, Rh or Raney-Ni is used as metal catalyst.

17. A formulated photoresist prepared from a polymer obtainable by a process according to claim 1.
